(19) United States
(12) Patent Application Publication
(10) Pub. No.: US 2019/0079508 A1
(43) Pub. Date: Mar. 14, 2019

(54) DEVICES AND METHOD OF WIRELESS ATTITUDE MEASUREMENT AND CONTROL OF GROUND VEHICLE ORIENTATION

(71) Applicants: Herbert Ross Gingold, Longwood, FL (US); Victoria Elizabeth Gingold, Longwood, FL (US)

(72) Inventors: Herbert Ross Gingold, Longwood, FL (US); Victoria Elizabeth Gingold, Longwood, FL (US)

(21) Appl. No.: 16/128,257

(22) Filed: Sep. 11, 2018

Related U.S. Application Data
(60) Provisional application No. 62/557,598, filed on Sep. 12, 2017.

(51) Int. Cl. G05D 1/00; G05D 1/08

(52) U.S. Cl. CPC G05D 1/005; G05D 1/0891; G05D 1/0016

(57) ABSTRACT

A collection of wirelessly connected devices monitored and controlled by a proportional-integral-derivative (PID) control loop application software executing on a wirelessly connected non-dedicated controller, that combine to form a wireless feedback control system that can manipulate the orientation of a vehicle frame to desired state. An inertial measurement unit (IMU), with six degrees of freedom, measures attitude with respect to gravity, is paired with wirelessly connected control mechanisms that effect the attitude of the vehicle, when controlled by software application that executes on the user provided smart phone or tablet, a closed loop control system is created that is completely wireless and where the controlling element is user provided and not dedicated to the system. The wireless sensor data is used in the PID control loop executing on the smart phone or tablet which calculates the needed attitude changes to achieve the desired orientation and converts these into a series of signals to the actuators, moving each in small increments to ensure the load remains balanced by keeping all control surfaces in contact with the ground at all times, ensuring the frame of the vehicle is not subjected in torque which can cause the frame to distort.

### CROSS-REFERENCE TO RELATED APPLICATIONS

This application claims the benefit of Provisional Application No. 62/557,598 filed on Sep. 12, 2017, the contents of which are incorporated herein by reference.

### BACKGROUND OF THE INVENTION

The statements in this section merely provide background information related to the present disclosure and may not constitute prior art.

The present invention relates generally to actively controlling the level of a vehicle frame, where the level sensing, and control elements are all connected wirelessly to a control unit, which interprets the level condition sent from the sensor and then actuates control elements to attain a desired orientation.

Leveling technology has advanced from bob and string to the bubble level over thousands of years, these allowed for one degree of freedom in level measurement. Mechanical devices allowed multi-dimensional measurement, however severe limitations in axis to axis alignment impaired the use of these measurements in calculating the roll and pitch angles of a surface. Accelerometers allowed for accurate electronic measurement of all three-dimensional accelerations, but size and mechanical issues limited the successful implementation of three-axis calculated roll and pitch angles. The invention of the three-axis Micro-Electro-Mechanical Systems (MEMS) accelerometer provided the size, axis to axis precision and accuracy of acceleration measurements needed for reliable roll and pitch calculations. Introduction of full inertial measurement MEMS devices, which have both linear and rotational acceleration sensors, provide six degrees of freedom of sensing for accurate and stable measurements.

With accurate level information you can manipulate a surface or object into a level, or predetermined offset thereof, configuration with respect to gravity using control elements which are typically electric motor driven or operated by electrically controlled hydraulic pistons.

Leveling of vehicles, which includes but in not limited to, recreational vehicles, tiny homes, permanent living trailers, boats on trailers, farm equipment, industrial equipment and others have specific needs for being brought to a specific orientation. The clearest examples are leveling a recreational vehicle for comfort, or lifting the nose of a trailer to the correct height for connection to the hitch.

Wireless technology has expanded to the point that almost all people carry with them a sophisticated computer, with high resolution display and multiple standard wireless technologies; the cell or smart phone, or tablet. The device is a key enabler of this patent.

Electric and hydraulic actuators are prior art. Level sensors are prior art. Wirelessly connected sensors and actuators are new technology, but also prior art, yet there are new and novel applications and use cases developed when they are combined to perform a function.

### BRIEF SUMMARY OF THE INVENTION

The present invention is a collection of wirelessly connected devices and application software executing on a wirelessly connected controller, that combine to form a wireless feedback control system that can manipulate the orientation of a vehicle frame to a desired state. The preferred embodiment of the present invention has a wireless battery operated three-axis MEMS accelerometer level sensing device that connects to a smart phone or tablet via the Bluetooth Low Energy (BLE) wireless standard. The embodiment has one or more BLE connected control devices that can control electric actuators and affect the attitude of the vehicle. The embodiment has a software application that executes on the user provided smart phone or tablet, and utilizes the smart phone's BLE radio to connect to the sensor and actuators. The embodiment creates a closed loop control system that is completely wireless and where the controlling element is user provided and not dedicated to the system. The embodiment uses the received wireless sensor data, calculates the needed attitude changes via a proportional-integral-derivative (PID) control loop, then generates a series of pulsed signals to the actuators, moving each in small increments to ensure the load remains balanced by keeping all control surfaces in contact with the ground at all times. This ensures the frame of the vehicle is not subjected to torque which can cause the frame to bend.

In one embodiment the sensors are connected to the vehicle power system.

In one embodiment the actuators are connected to a battery power.

In one embodiment the invention uses any other standard wireless connection commonly available on a smart phone or tablet, or any standard wireless connection.

In one embodiment there are multiple sensors to detect the attitude of the vehicle including but not limited to: multiple single axis accelerometers, audio and/or infrared and/or radar ranging devices and/or capacitive tilt sensor and/or inertial measurement units (IMU).

In one embodiment the control loop uses an algorithm other than PID.

In one embodiment the control signals could have any reasonable sequence or pattern that keeps the vehicle frame moving toward the desired attitude while ensuring an even load and constant ground contact.

In one embodiment additional feedback is provided to the control loop by current measurement of the electric actuator.

In one embodiment additional feedback is provided to the control loop by pressure measurement of the hydraulic actuator.

In one embodiment the application executing on the user provided smart phone or tablet is used in a manual control mode where the user can preset targets or manually input changes to the application software, which interprets these to control the surface via the actuators.

### BRIEF DESCRIPTION OF THE DRAWINGS

Presently the preferred embodiments are shown in the drawings. It should be appreciated, however, that the invention is not limited to the precise arrangements and instrumentalities shown.

FIG. 1 is the top and bottom assembly views of the acceleration sensing device.

FIG. 2 is the top assembly view of the electric motor control device.

FIG. 3 is the application software control panel image before connection to the sensing and control devices.

FIG. 4 is the application software control panel image after connection to the sensing and control devices.

FIG. 5 is the top and side views of a typical single axle trailer with acceleration sensor and electric nose control jack. Also shown is the representation of the smart phone or tablet.

FIG. 6 is the top and side views of a typical single axle trailer with acceleration sensor, electric nose control jack and two electric rear lifting jacks. Also shown is the representation of the smart phone or tablet.

FIG. 7 is the top and side views of a typical single axle trailer with acceleration sensor, two electric front lifting jacks, and two electric rear lifting jacks. Also shown is the representation of the smart phone or tablet.

FIG. 8 is the top and side views of a typical double axle trailer with acceleration sensor, two electric front lifting jacks, and two electric rear lifting jacks. Also shown is the representation of the smart phone or tablet.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

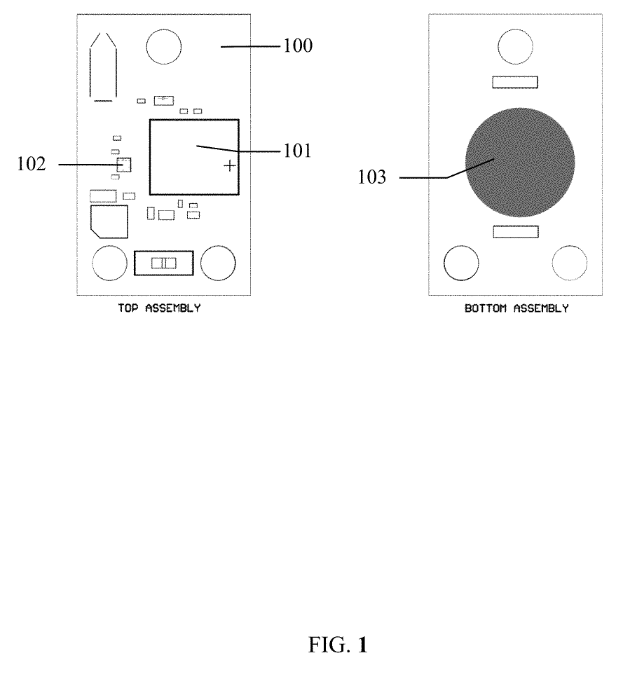

FIGS. 1-8 illustrate an embodiment of a wirelessly connected closed loop control system comprised of an acceleration measurement sensor, one or more electrically operated jacks controlled by a wireless electronic control board, both of which are wirelessly connected to a user provided smart phone or tablet which takes the acceleration information and determines the required jack movement to achieve level with respect to gravity, or a designed orientation that is offset from gravity level.

In FIG. 1 the acceleration sensing device 100 is shown. The device has a Bluetooth Low Energy (BLE) radio and microprocessor combination module 101. The device has a Micro-Electro-Mechanical Systems (MEMS) acceleration sensor 102 to sense the orientation relative to gravity. There is a primary cell lithium ion battery 103 to provide power.

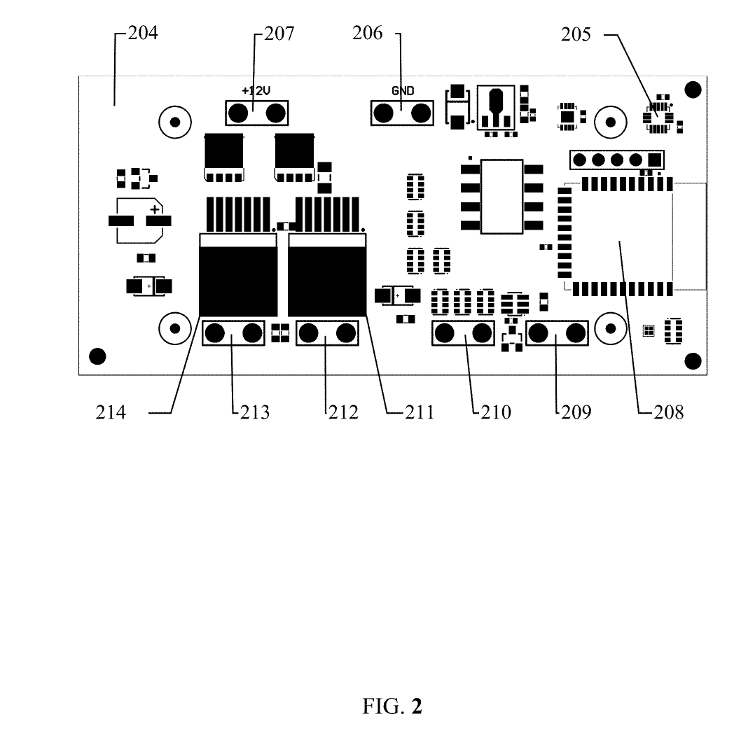

In FIG. 2 the wireless electric motor control device 204 is shown. The device has an acceleration sensor 205 used for motion detection safety interlock. The device has a Bluetooth Low Energy (BLE) radio and microprocessor combination module 208. There are six ¼-inch quick disconnect tabs for electrical connection. Tab 206 is the ground connection. Tab 207 is the 12-volt DC connection. Tab 209 is the input for manual switch B. Tab 210 is input for manual switch A. Tab 212 is the output for channel 2. Tab 213 is the output for channel 1. The device has two half bridge 12-volt high side and low side combination drivers 211 and 214 for motor control.

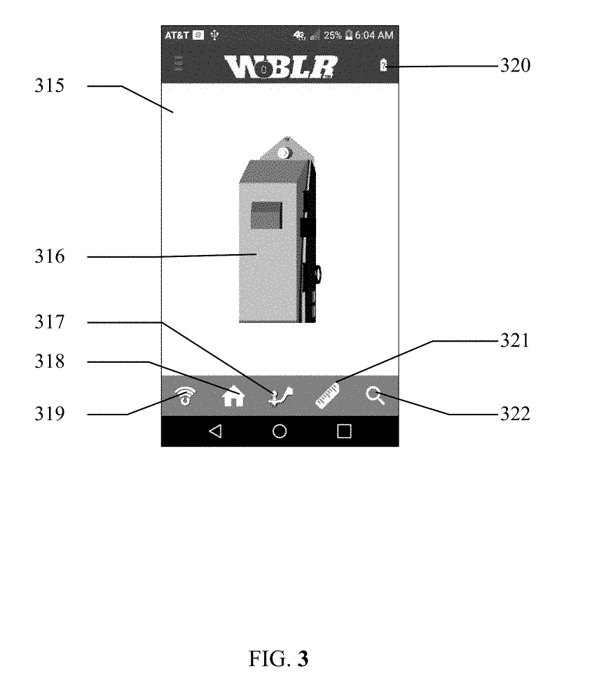

In FIG. 3 the smart phone control application 315 is shown before connection to sensors and controllers. The application shows an image of a vehicle 316. There is an indicator 317 that is used to connect and show connections to jacks. There is an indicator 318 that is used to calibrate the sensor and to show it is calibrated. There is an indicator 319 that is used to connect to the acceleration sensor and to show it is connected. There is an indicator 320 that shows that state of the battery of the acceleration sensor. There is an indicator 321 that is used to configure the application to correctly show the error values between the desired attitude and the current attitude and indicate that the configuration is valid. There is an indicator 322 that is used to increase or decrease the system gain of the PID control loop.

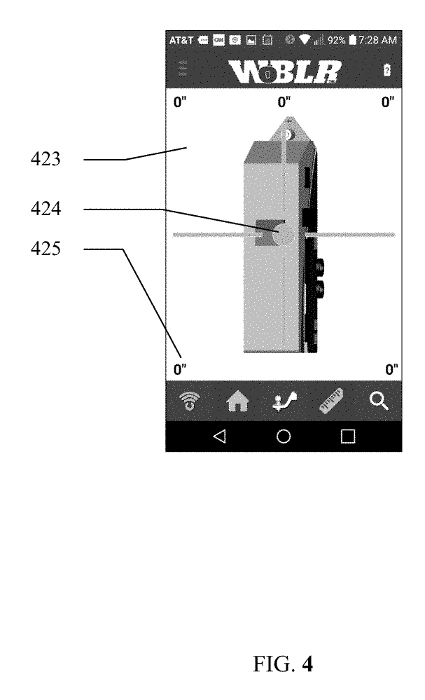

In FIG. 4 the smart phone control application 423 is shown after connection to the sensor and controllers. The application shows the bubble display of the current level status of the sensor 424. There are indicator values 425 that display the calculated error between the current and desired attitude.

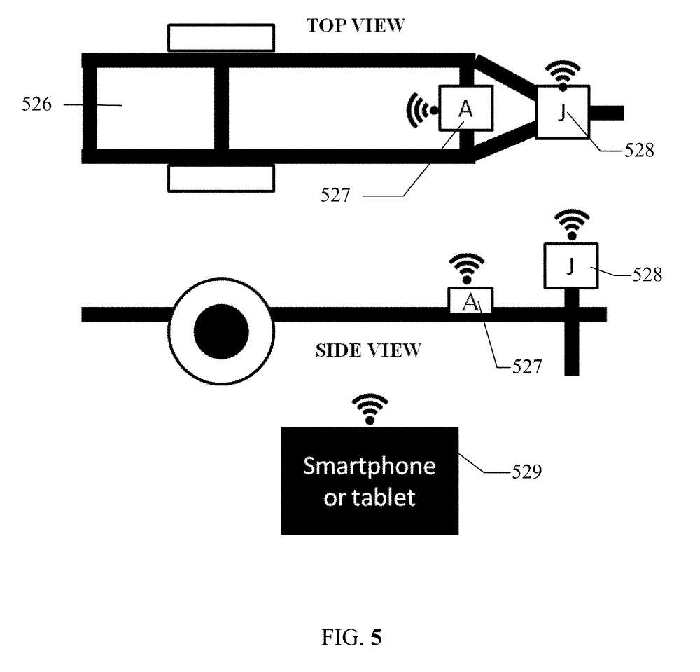

In FIG. 5 a representation of a single axle trailer 526 with a single lifting jack is shown. The trailer is fitted with an acceleration sensor 527 shown in an arbitrary location. There is a nose lifting jack 528 controlled by the wireless electronic control board. The lifting jack 528 is shown in side view. The acceleration sensor 527, arbitrarily located, is show in side view. There is a user provided smart phone or tablet 529 that wirelessly receives data from the acceleration sensor 527 and sends commands to the jack control board 528.

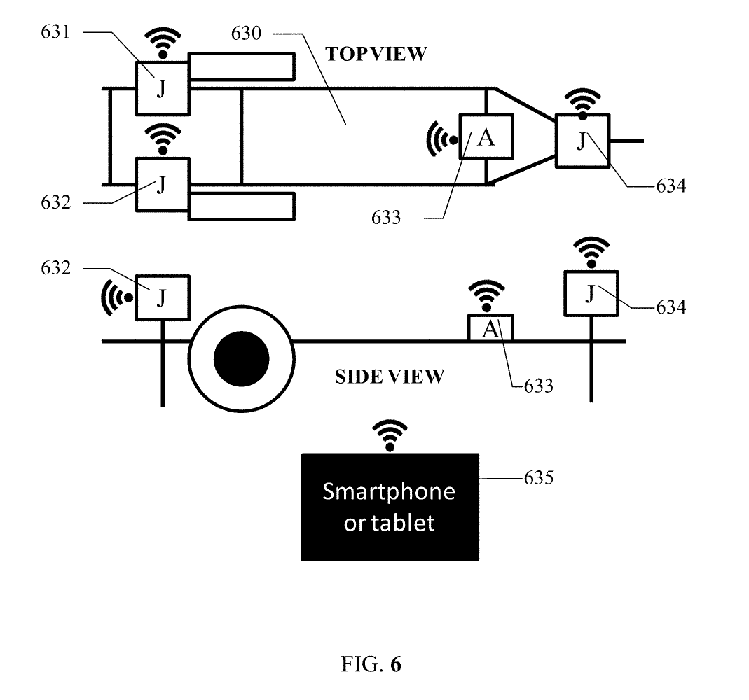

In FIG. 6 a representation of a single axle trailer 630 with three lifting jacks is shown. The trailer is fitted with an acceleration sensor 633 shown in an arbitrary location. There is a nose lifting jack 634 controlled by the wireless electronic control board. There is a left rear electric lifting jack 631 controlled by the wireless electronic control board. There is a right rear electric lifting jack 632 controlled by the wireless electronic control board. The nose lifting jack 634 is shown in side view. The acceleration sensor 633, arbitrarily located, is show in side view. The right rear lifting jack is shown in side view 632. There is a user provided smart phone or tablet 635 that wirelessly receives data from the acceleration sensor 633 and sends commands to the jack control boards 631, 632 and 634.

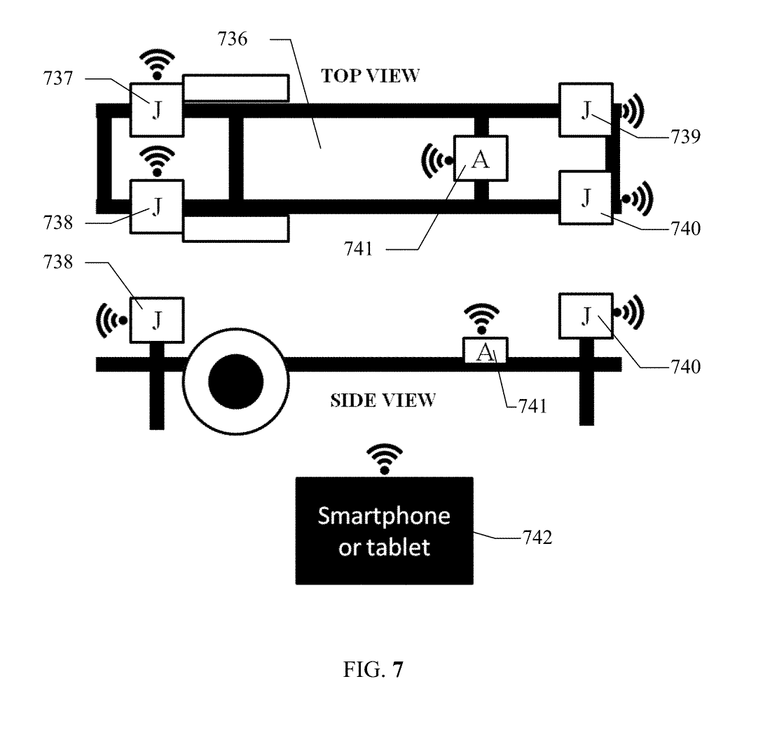

In FIG. 7 a representation of a single axle trailer 736 with four lifting jacks is shown. The trailer is fitted with an acceleration sensor 741 shown in an arbitrary location. There is a left front lifting jack 739 controlled by the wireless electronic control board. There is a right front lifting jack 740 controlled by the wireless electronic control board. There is a left rear lifting jack 737 controlled by the wireless electronic control board. There is a right rear lifting jack 738 controlled by the wireless electronic control board. The right front lifting jack 740 is shown in side view. The acceleration sensor 741, arbitrarily located, is show in side view. The right rear lifting jack is shown in side view 738. There is a user provided smart phone or tablet 742 that wirelessly receives data from the acceleration sensor 741 and sends commands to the jack control boards 737, 738, 739 and 740.

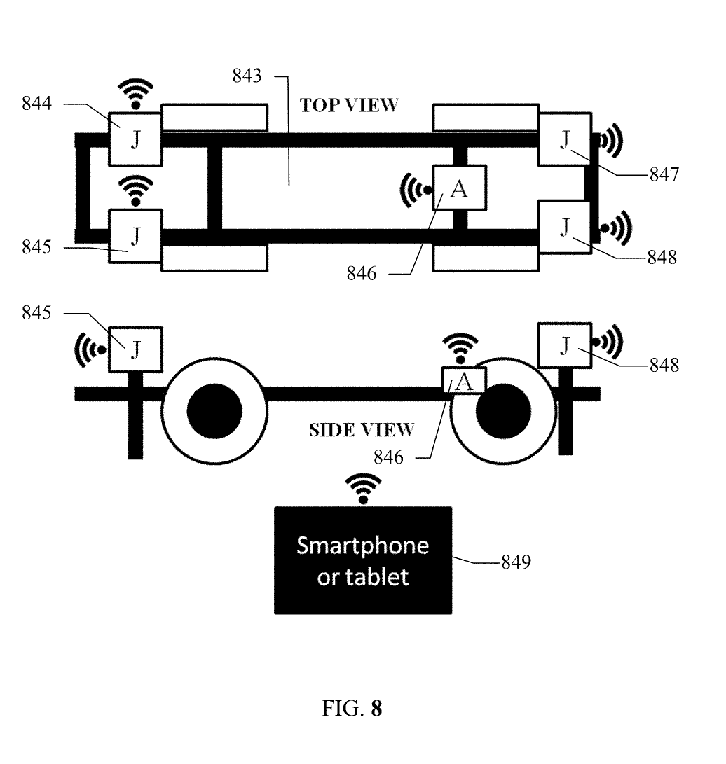

In FIG. 8 a representation of a double axle vehicle 843 with four lifting jacks is shown. The vehicle is fitted with an acceleration sensor 846 shown in an arbitrary location. There is a left front lifting jack 847 controlled by the wireless electronic control board. There is a right front lifting jack 848 controlled by the wireless electronic control board. There is a left rear lifting jack 844 controlled by the wireless electronic control board. There is a right rear lifting jack 845 controlled by the wireless electronic control board. The right front lifting jack 848 is shown in side view. The acceleration sensor 846, arbitrarily located, is show in side view. The right rear lifting jack is shown in side view 845. There is a user provided smart phone or tablet 849 that wirelessly receives data from the acceleration sensor 846 and sends commands to the jack control boards 844, 845, 847 and 848.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the present steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The claimed invention is:

1. A collection of wirelessly connected attitude sensors and motion actuators that are combined with a user provided smart phone or tablet controller executing a proportional-integral-derivative (PID) based control loop program that manipulates the attitude of a vehicle frame to a desired orientation:
That it uses a sensor that provides orientation with respect to gravity;
That the system can be fully battery operated;
That it uses the current of the electric motor as an additional feedback to the control PID algorithm;
That it uses the pressure of the hydraulic actuator as an additional feedback to the control PID algorithm;
That it uses the current of the electric motor as an additional feedback to determine the contact with ground;
That it uses the pressure of the hydraulic actuator as an additional feedback to determine the contact with ground.

2. A system as described in claim 1 that the application executing on the user provided smart phone or tablet creates a pattern of control signals that ensure that all attitude controlling actuators minimize undesired torque of the vehicle:
That the pattern, pulse width and overall duration of the pulses can be any valid value;
That electrical current on each electrical actuator is a feedback is used to determine the relative amount of force and load for the purpose of load balancing;
That hydraulic pressure on each hydraulic actuator is a feedback is used to determine the relative amount of force and load for the purpose of load balancing.

3. A system as described in claim 1 that the application executing on the user provided smart phone or tablet has a manual control mode that is enhanced by the PID control system to provide inherent stability to the platform by rate of change and absolute attitude limitations:
That it has the ability to positively or negatively, and dynamically vary the gains of the PID control loop during manual mode;
That the manual control can be dynamically controlled by the user interfacing with the user provided smart phone;
That the manual control can have arbitrary targets created by the user on the provided smart phone or tablet.
